(19) United States
(12) Patent Application Publication
(10) Pub. No.: US 2014/0134077 A1
(43) Pub. Date: May 15, 2014

(54) SAMPLE LIQUID INJECTION TOOL AND SAMPLE LIQUID HEAT TREATMENT APPARATUS

(71) Applicant: Sony Corporation, Tokyo (JP)

(72) Inventors: Tasuku Yotoriyama, Tokyo (JP); Yuji Segawa, Tokyo (JP); Michihiro Ohnishi, Kanagawa (JP); Yoshiaki Kato, Gunma (JP); Tomoteru Abe, Tokyo (JP); Kenzo Machida, Kanagawa (JP); Masahiro Matsumoto, Kanagawa (JP); Tomohiko Nakamura, Tokyo (JP); Naohisa Sakamoto, Tokyo (JP); Hidetoshi Watanabe, Chiba (JP); Takanori Anaguchi, Kanagawa (JP); Masayoshi Akita, Tokyo (JP); Masahiro Miyachi, Tokyo (JP)

(73) Assignee: Sony Corporation, Tokyo (JP)

(21) Appl. No.: 14/073,382

(22) Filed: Nov. 6, 2013

(30) Foreign Application Priority Data
Nov. 13, 2012 (JP) 2012-249726

(51) Int. Cl. B01L 3/02; B01L 7/00

(52) U.S. Cl. CPC B01L 3/0217; B01L 7/00
USPC 422/513

(57) ABSTRACT

There is provided a sample liquid injection tool including a reservoir section configured to store a sample liquid, a channel having one end protruding from an outer surface and configured to discharge the sample liquid therein from a protrusion end to an outside, and a heating unit and a filter installed between the reservoir section and the channel to enable passage of the liquid.

### CROSS REFERENCES TO RELATED APPLICATIONS

The present application claims priority to Japanese Priority Patent Application JP 2012-249726 filed in the Japan Patent Office on Nov. 13, 2012, the entire content of which is hereby incorporated by reference.

### BACKGROUND

The present disclosure relates to a sample liquid injection tool and a sample liquid heat treatment apparatus, and more particularly, to a sample liquid injection tool, and so on, configured to simply perform pretreatment of a sample liquid.

In recent times, microchips having silicon or glass substrates on which wells or flow paths are formed to perform chemical and biological analysis have been developed by applying a fine processing technique in the semiconductor industry. These microchips are beginning to be used in, for example, electrochemical detectors of liquid chromatography, small electrochemical sensors in the medical field, or the like.

An analysis system using the microchip is referred to as a μ-TAS (a micro-total-analysis system), a lab-on-chip, a biochip, or the like, and is receiving attention as a technique capable of realizing a high speed or high efficiency of chemical and biological analysis, or a compact size of an analysis apparatus. Since the μ-TAS can perform the analysis using a small amount of specimen and the microchip may be used as a disposable part, in particular, application to the biological analysis in which a small amount of precious specimen or a plurality of sample materials are handled is expected.

As an application example of the μ-TAS, an optical detecting apparatus configured to introduce a material into a plurality of regions disposed on a micro chip and chemically detect the material is provided. As such an optical detecting apparatus, for example, a reaction apparatus (for example, a real time PCR apparatus) or the like configured to progress reactions between a plurality of materials such as a nucleic acid amplification reaction or the like on a micro chip and optically detect the generated materials is provided.

In analysis using the μ-TAS, since a small amount sample is provided, it is difficult to introduce the sample into the region such as the wall or the like disposed on the micro chip, and when the sample is introduced into the micro chip, bubbles may enter the micro chip.

Here, in order to solve the problem, for example, Japanese Patent Application Laid-open No. 2012-2508 discloses “a sample liquid supply container including a first penetration unit having a first region, in which a pressure is reduced and hermetically sealed, and a second region configured to contain a liquid, and through which a hollow needle penetrates the inside of the first region from the outside; and a second penetration unit in which the hollow needle inserted into the first penetration unit and arriving at the inside of the first region penetrates the inside of the second region. In the sample liquid supply container, air in the micro chip is suctioned using a negative pressure of the first region, and then, the sample liquid in the second region is introduced into the micro chip using the negative pressure in the micro chip.

### SUMMARY

According to the above-mentioned sample liquid supply container, the small amount of sample liquid can be conveniently introduced into the micro chip. However, in many cases, the sample liquid supplied into the micro chip should be appropriately pretreated according to an analysis technique, and it is difficult to pretreat the small amount of sample liquid. Here, the present disclosure provides a sample liquid injection tool capable of conveniently performing pretreatment of a sample liquid.

According to an embodiment of the present application, there is provided a sample liquid injection tool including a reservoir section configured to store a sample liquid, a channel having one end protruding from an outer surface and configured to discharge the sample liquid therein from a protrusion end to an outside, and a heating unit and a filter installed between the reservoir section and the channel to enable passage of the liquid.

The sample liquid injection tool may further include a cylinder conduit line having one end opened at the outside and the other end in communication with a space to which the channel is directly connected, a plunger inserted into the cylinder conduit line, and a gas liquid separation film disposed inside the cylinder conduit line or at a communication hole to the space.

The sample liquid injection tool may further include a thermal conductive member installed at the heating unit. The thermal conductive member may be able to come in contact with the sample liquid accommodated in the heating unit, and a portion of the thermal conductive member may be disposed to be exposed to the outside.

A diameter of the channel may preferably be smaller than a diameter of a passing area of the sample liquid between the reservoir section and the channel.

A volume of the heating unit may preferably be smaller than a volume of the reservoir section.

The heating unit may be connected to the reservoir section and a space in which the filter is disposed may be connected to the heating unit, and the channel and the cylinder conduit line may be in communication with the space at a downstream side in a liquid-passing direction of the filter.

Values may be disposed at the passing area of the sample liquid between the reservoir section and the heating unit, and between the heating unit and the space.

A communication hole of the cylinder conduit line to the space may preferably be disposed closer to a communication hole of the channel to the space than a connecting hole of the heating unit to the space.

The thermal conductive member may be formed of copper or aluminum, and an average hole diameter of the filter may preferably be 0.1 to 10 μm.

The channel may penetrate a microchip in which a groove into which the sample liquid is introduced is formed, and an inner space of the groove may preferably become a negative pressure with respect to an atmospheric pressure.

Further, the tool may preferably be formed by stacking substrate layers formed of plastic.

Further, an insertion section into which the microchip is inserted may preferably be configured between the substrate layers, and the channel may have one end protruding to the insertion section in a layer direction of the substrate layers.

The filter may be disposed between the reservoir section and the heating unit, and the channel and the cylinder conduit line may come in communication with the heating unit.

Further, according to an embodiment of the present application, there is provided a sample liquid heat treatment apparatus including a heater in contact with the thermal conductive member of the sample liquid injection tool. The heater may be a Peltier element.

According to the present disclosure, a sample liquid injection tool capable of conveniently performing heat treatment and filtration with respect to a sample liquid is provided.

Additional features and advantages are described herein, and will be apparent from the following Detailed Description and the figures.

### BRIEF DESCRIPTION OF THE FIGURES

FIGS. 1A and 1B is schematic view showing a constitution of a sample liquid injection tool according to a first embodiment of the present disclosure, FIG. 1A is a top view, and FIG. 1B is a cross-sectional view taken along line L₁-L₁ of FIG. 1A;

FIGS. 2A to 2D is a schematic view for describing pretreatment of a sample liquid by the sample liquid injection tool according to the first embodiment;

FIG. 3 is a schematic view showing a constitution of a sample liquid injection tool according to a variant of the first embodiment, FIG. 3A is a top view, and FIG. 3B is a cross-sectional view taken along line L₂-L₂ of FIG. 3A;

FIGS. 4A to 4D is a schematic view for describing pretreatment of a sample liquid by the sample liquid injection tool according to the variant of the first embodiment;

FIG. 5 is a cross-sectional schematic view showing a constitution of a sample liquid injection tool according to a second embodiment of the present disclosure;

FIGS. 6A to 6D is a schematic view for describing pretreatment of a sample liquid by the sample liquid injection tool according to the second embodiment;

FIG. 7 is a cross-sectional schematic view showing a constitution of a sample liquid injection tool according to a variant of the second embodiment; and

FIGS. 8A and 8B is a schematic view for describing pretreatment of a sample liquid by the sample liquid injection tool according to the variant of the second embodiment.

### DETAILED DESCRIPTION

Hereinafter, preferred embodiments of the present disclosure will be described. In addition, the embodiments described below are provided as representative embodiments of the present disclosure, but the scope of the present disclosure is not understood to a narrow range by the embodiments. Description will be provided in the following sequence.
1. Constitution of sample liquid injection tool according to first embodiment of present disclosure
(1) Reservoir section
(2) Heating unit
(3) Syringe conduit line
(4) Filter accommodating section
(5) Channel
(6) Insertion section
2. Pretreatment and injection of sample liquid by sample liquid injection tool according to first embodiment
3. Constitution of sample liquid injection tool according to variant of first embodiment
(1) Filter accommodating section
(2) Heating unit
4. Constitution of sample liquid injection tool according to second embodiment of present disclosure
(1) Reservoir section
(2) Filter
(3) Heating unit
(4) Channel
5. Pretreatment and injection of sample liquid by sample liquid injection tool according to second embodiment
6. Constitution of sample liquid injection tool according to variant of second embodiment
(1) Heating unit
(2) Channel
(3) Insertion section

1. Constitution of sample liquid injection tool according to first embodiment of present disclosure

In the sample liquid injection tool according to the present disclosure, a liquid (a sample liquid) in which a reagent solution and a specimen are mixed is prepared by pretreatment of heating and filtration, and injected into a microchip, or the like, on which a fine structure such as a well or the like is formed.

In the sample liquid injection tool according to the present disclosure, the specimen may generally include nucleic acid, protein, cells, or the like. The specimen may be, for example, a biological specimen or the like such as a swab (wiped liquid, nasal mucus, phlegm, or the like, of the nose or the throat), blood, tears, urine, or the like.

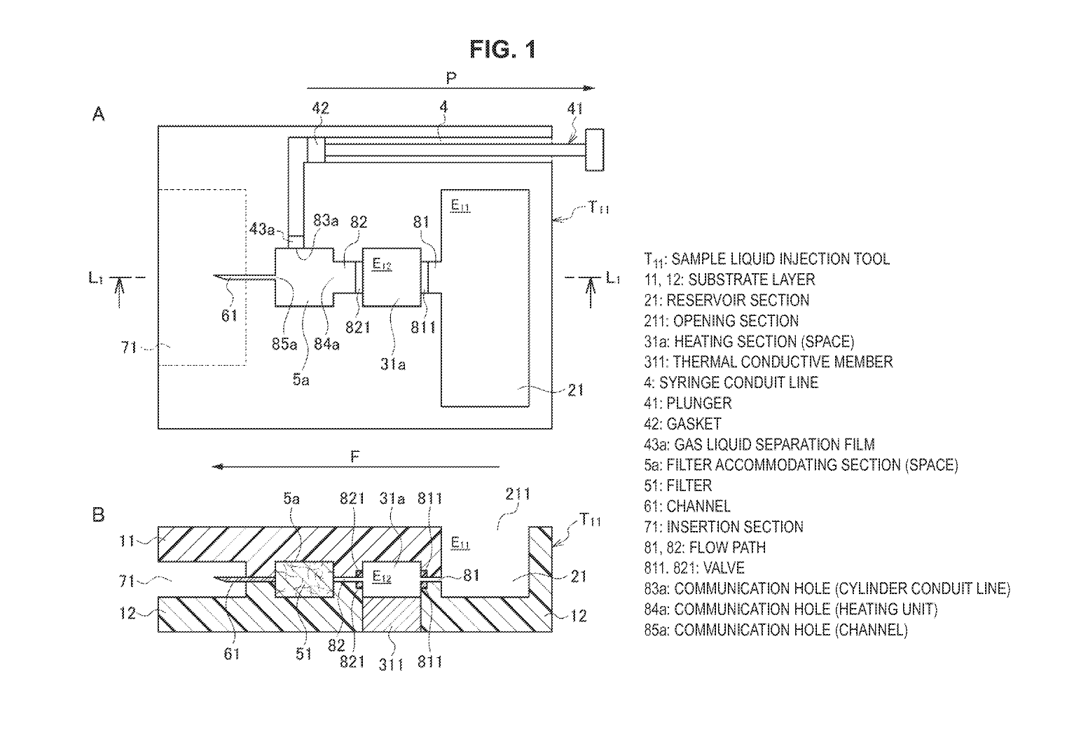

FIG. 1 is a schematic view of a sample liquid injection tool designated by reference character T₁₁. FIG. 1A is a top view and FIG. 1B is a cross-sectional view taken along line L₁-L₁ of FIG. 1A. As shown in FIG. 1A, the sample liquid injection tool T₁₁ includes a reservoir section 21 in which a sample liquid is stored, a channel 61 having one end protruding from an outer surface thereof and configured to discharge the sample liquid disposed therein from a protrusion end toward the outside, and a heating unit 31a and a filter 51 disposed between the reservoir section 21 and the channel 61 and through which a liquid can pass. The reservoir section 21 is connected to the heating unit 31a via a flow path 81, and the heating unit 31a is connected to a space (a filter accommodating section 5a), in which the filter 51 is disposed, via a flow path 82. In addition, the filter accommodating section 5a comes in communication with the channel 61 and a cylinder conduit line 4 at a downstream side in a liquid-passing direction of the mixed liquid of the filter 51.

As shown in FIG. 1B, the sample liquid injection tool T₁₁ is constituted by stacking a plurality of substrate layers 11 and 12. In FIG. 1B, while the case in which the sample liquid injection tool T₁₁ is constituted by two substrate layers of the substrate layer 11 and the substrate layer 12 is shown, the number of substrate layers is not particularly limited.

Various kinds of plastics may be used in a material of the substrate layers 11 and 12 that constitute the sample liquid injection tool T₁₁. The plastics may include, for example, PMMA (polymethyl methacrylate: acryl resin), PC (polycarbonate), PS (polystyrene), PP (polypropylene), PE (polyethylene), PET (polyethylene terephthalate), and so on. In addition, the same material or different materials may be used in the substrate layer 11 and the substrate layer 12.

The sample liquid accommodated in the reservoir section 21 of the sample liquid injection tool T₁₁ flows through the sample liquid injection tool T₁₁ to arrive at the channel 61 (see FIG. 1A) by movement of a plunger 41 in a syringe conduit line 4 (to be described below) in a direction of an arrow designated by reference character F. Hereinafter, the respective components of the sample liquid injection tool T₁₁ will be described.

(1) Reservoir Section

The reservoir section 21 is a space E₁₁ formed in the sample liquid injection tool T₁₁, and a region configured to accommodate a reagent solution necessary for preparation of the sample liquid. The reagent solution may include elements necessary for preparation of the sample liquid, and may be appropriately selected according to a kind of analysis. The reagent solution may include, for example, a surfactant, a buffer solution, or the like. In addition, when some of the reagent necessary for the analysis is accommodated in a microchip or the like, the reagent solution accommodated in the reservoir section 21 may include only an element necessary for pretreatment of the specimen using the sample liquid injection tool T₁₁.

The reagent solution and the specimen can be mixed in the reservoir section 21. For example, when the specimen is a swab, a cotton swab in which a swab is wiped (in FIG. 1, the cotton swab is not shown) may be guided to the reservoir section 21 from an opening section 211 and the swab may be suspended in the reagent solution. In this case, the opening section 211 having a size that enables stirring of the reagent solution by the cotton swab may be formed in the reservoir section 21. In addition, the reagent solution and the specimen may be mixed in a separate container, and the mixed liquid may be introduced into the reservoir section 21.

(2) Heating Unit

In the sample liquid injection tool T₁₁, the heating unit 31a includes a constitution configured to heat the sample liquid in which the reagent solution and the specimen accommodated in the reservoir section 21 are mixed. The heating unit 31a has the space E₁₂ configured to accommodate the mixed liquid, and includes a thermal conductive member 311 configured to transfer heat to the mixed liquid accommodated in the space E₁₂. The thermal conductive member 311 may be enable to come in contact with the sample liquid accommodated in the heating unit 31a, and a portion of the thermal conductive member 311 may be disposed at a position exposed to the outside of the sample liquid injection tool T₁₁. For example, as shown in FIG. 1B, the portion of the thermal conductive member 311 may be constituted as one surface of the space E₁₂, and may be constituted as an outer surface of the sample liquid injection tool T₁₁.

The thermal conductive member 311 is formed of a material having thermal conductivity. The material having the thermal conductivity may be, for example, a metal, ceramic, silicon, glass, or the like. The metal may be, for example, copper, aluminum, brass, stainless steel, or the like.

In order to reduce a heating time of the sample liquid by the heating unit 31a, a capacity of the space E₁₂ may be approximate to a capacity of the sample liquid necessary for the analysis using the microchip. The capacity of the sample liquid necessary for the analysis using the microchip may be generally about hundreds of microliters. Meanwhile, a volume of the space E₁₁ of the reservoir section 21 may be provided to accommodate the reagent solution to a level, for example, such that the cotton swab is immersed, and the reagent solution of about several milliliters is necessary. Accordingly, the volume of the heating unit 31a may be smaller than that of the reservoir section 21 (see FIGS. 1A and 1B).

In addition, a valve 811 configured to prevent backward flow of the sample liquid flowing through the heating unit 31a toward the reservoir section 21 may be installed at the flow path 81 that connects the reservoir section 21 and the heating unit 31a. For example, as shown in FIG. 1B, a portion having different hydrophilic and hydrophobic properties from the other portion may be formed at a portion of the surface that constitutes the flow path 81 to function as the valve 811. As the hydrophilic and hydrophobic properties of the wall surface of the flow path 81 are varied at a portion of the flow path 81, the flowing of the sample liquid through the flow path 81 can be prevented until an external force is applied to the sample liquid by movement of the plunger 41 (to be described below).

In addition, a thermoplastic material such as a wax or the like is provided in the flow path 81, and this may be used as the valve 811. In this case, the thermoplastic material (the valve 811) in the flow path 81 is melted using a laser or the like, and opening and closing of the flow path are controlled. Furthermore, as a portion of the wall surface of the flow path 81 is constituted by a member having elasticity and the elastic member is pressed from the outside of the sample liquid injection tool T₁₁, a function of the valve 811 may be provided to the sample liquid injection tool T₁₁. As the elastic member is pressed from the outside of the sample liquid injection tool T₁₁ and the inner space of the flow path 81 is closed, the flowing of the sample liquid through the flow path 81 can be prevented.

(3) Syringe Conduit Line

In the sample liquid injection tool T₁₁, the syringe conduit line 4 is a region into which the plunger 41 is inserted, and has one end opened at the outside of the sample liquid injection tool T₁₁ and the other end in communication with a space (the filter accommodating section 5a) to which the channel 61 is directly connected. In a pretreatment method of the sample liquid by the sample liquid injection tool T₁₁ (to be described below), the syringe conduit line 4 is configured to flow the sample liquid accommodated in the reservoir section 21 to the channel 61. In addition, a scale using a reference when a user pulls the plunger 41 or a locking structure configured to lock the plunger 41 once at a predetermined position in sliding movement in the syringe conduit line 4 of the plunger 41 may be installed at the syringe conduit line 4.

The material of the plunger 41 is not particularly limited, and may be the same material as or a different material from the substrate layers 11 and 12. In addition, in order to increase adhesion between the wall surface of the syringe conduit line 4 and the plunger 41, a material having elasticity may be used in a gasket 42 of the plunger 41. The material having elasticity may be, for example, a silicon-based elastomer, an acryl-based elastomer, a urethane-based elastomer, a fluorine-based elastomer, a styrene-based elastomer, an epoxy-based elastomer, natural rubber, and so on.

(4) Filter Accommodating Section

In the sample liquid injection tool T₁₁, the filter accommodating section 5a is a space in which the filter 51 is accommodated. The filter 51 is used to separate impurities included in the sample liquid from the analysis target.

A material of the filter may be, for example, cellulose acetate, regenerated cellulose, polyethersulfone, glass fiber, nylon, polytetrafluoroethylene, and so on. For example, when the analysis target included in the sample liquid is the nucleic acid, a material having hydrophilicity and negative electric charges in the sample liquid may be used in the filter. In addition, when the analysis target is the nucleic acid, it is preferable that an average hole diameter of the filter has a size such that a cell membrane or a cell organelle does not pass therethrough, which may be 0.1 to 10 μm. When the average hole diameter is smaller than that size, a recovery rate of a nucleic acid chain is decreased. Meanwhile, when the average hole diameter is larger than that size, removal efficiency of a material not necessary for the analysis, such as the cell membrane, the cell organelle, or the like, other than the nucleic acid chain, is decreased.

(5) Channel

The channel 61 is a tubular structure connected to the filter accommodating section 5a at one end thereof, which is, for example, a hollow needle. The other end of the channel 61 is disposed such that the one end protrudes toward an insertion section 71 in a layer direction of the substrate layers 11 and 12.

(6) Insertion Section

In the sample liquid injection tool T₁₁, the insertion section 71 is a portion into which a member for analysis such as a microchip or the like is inserted, which corresponds to notch sections of the substrate layers 11 and 12 (see FIG. 1B). While a size of the insertion section 71 is set not to disturb connection of the microchip and the channel 61, when the size of the insertion section 71 is substantially the same as an insertion portion of the microchip to the insertion section 71, in a penetration of the microchip by the channel 61, which will be described below, positioning of the penetration becomes easy. In addition, as the insertion section 71 is provided, the channel 61 does not protrude from the sample liquid injection tool T₁₁, and a user is prevented from puncturing his/her hand or the like by mistake in the channel 61.

2. Pretreatment and injection of sample liquid by sample liquid injection tool according to first embodiment

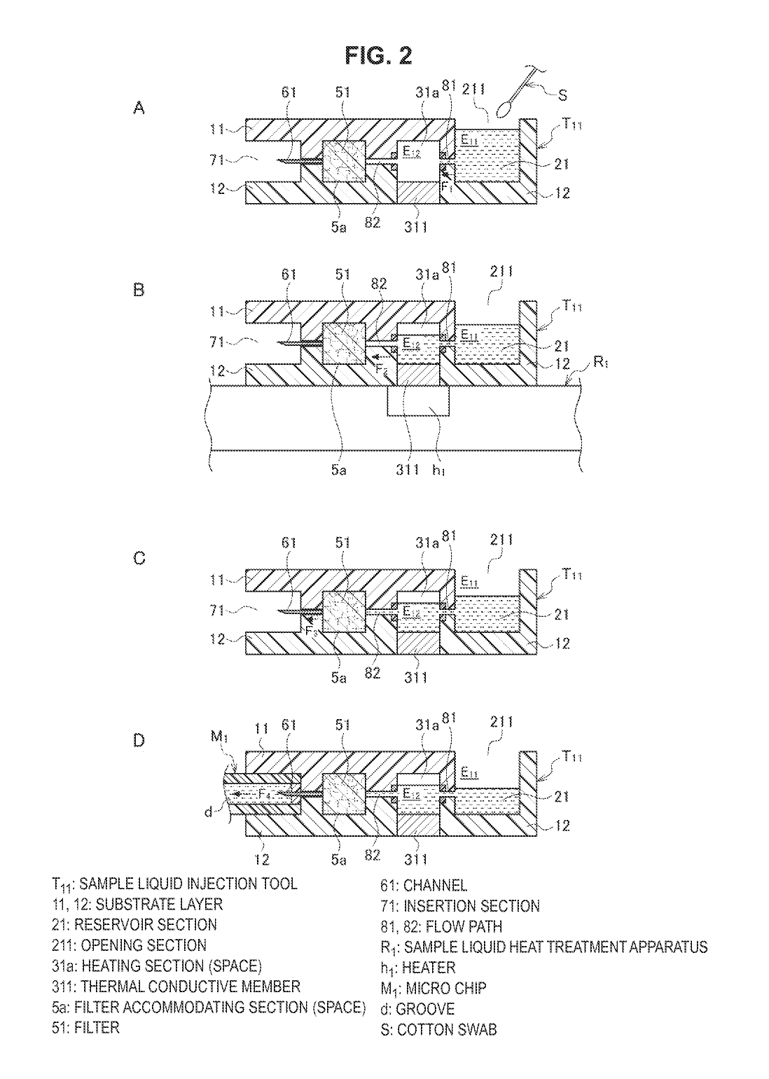

Pretreatment of the sample liquid and injection into the microchip using the above-mentioned sample liquid injection tool T₁₁ will be described with reference to FIGS. 1 and 2. FIGS. 2A to 2D correspond to cross-sections taken along line L₁-L₁ of FIG. 1A, like FIG. 1B.

FIG. 2A shows a state in which a reagent solution is accommodated in the reservoir section 21, a cotton swab S to which a swab is attached is immersed in the reagent solution, and a specimen (the swab) is suspended in the reagent solution.

When the suspension of the specimen in the reagent solution is terminated, as shown in FIG. 2B, some of the suspension (the sample liquid) accommodated in the reservoir section 21 passes through the flow path 81 to be introduced into the heating unit 31a. Movement of the sample liquid in the sample liquid injection tool T₁₁ is performed by pulling the plunger 41 inserted into the syringe conduit line 4 in a direction of the outside of the sample liquid injection tool T₁₁ as shown by an arrow P (see FIG. 1A).

When the plunger 41 is pulled in the direction of the arrow P, internal air of the sample liquid injection tool T₁₁ flows into the syringe conduit line 4, which has a negative pressure in comparison with the other region in the sample liquid injection tool T₁₁. The sample liquid accommodated in the reservoir section 21 flows through the flow path 81 to be introduced into the heating unit 31a according to movement of the internal air of the sample liquid injection tool T₁₁ (see an arrow F₁). In addition, in movement of the air caused by extracting the plunger 41 from the syringe conduit line 4, in order to prevent some of the sample liquid from flowing into the syringe conduit line 4, a gas liquid separation film 43a may be installed inside the cylinder conduit line 4 or a communication hole 83a to the space (the filter accommodating section 5a).

As shown in FIG. 2B, the sample liquid accommodated in the heating unit 31a is heated using, for example, a sample liquid heat treatment apparatus R₁. The sample liquid heat treatment apparatus R₁ includes a heater h₁ in contact with the thermal conductive member 311 of the sample liquid injection tool T₁₁. As the heater h₁ comes in contact with the thermal conductive member 311, heat generated from the heater h₁ is transmitted to the sample liquid. Furthermore, the sample liquid heat treatment apparatus R₁ includes a constitution configured to generate heat from the heater h₁ and control a heating temperature, a heating time, or the like, of the sample liquid.

The heating temperature and the heating time of the sample liquid may be appropriately set to match the kind of analysis target such as nucleic acid, protein, or the like, or the analysis technique. For example, when the analysis target is the nucleic acid, the heating temperature may be about 90° C. The nucleic acid included in the sample liquid becomes a straight chain shape by the heating. In addition, when cells such as bacteria or the like are included in the sample liquid, the cell membrane is broken by the heating or the heating and an element included in the reagent solution, and genomes present in the cells are diffused in the sample liquid.

In the heater h₁ of the sample liquid heat treatment apparatus R₁, for example, a Peltier element may be used. When the Peltier element is used in the heater h₁, in the sample liquid accommodated in the heating unit 31a, temperature control of the sample liquid generally including cooling as well as heating becomes possible. For example, when the analysis target is the nucleic acid, after the nucleic acid included in the sample liquid is given the straight chain shape by the heating, the sample liquid may be rapidly cooled to hold the straight chain shape.

The sample liquid, in which the heating is terminated, passes through the flow path 82 to be introduced into the filter accommodating section 5a. The communication hole 83a of the cylinder conduit line 4 to the space (the filter accommodating section 5a) is installed closer to a communication hole 85a of the channel 61 to the space (the filter accommodating section 5a) than a connecting hole (a communication hole 84a) of the heating unit 31a to the space (the filter accommodating section 5a). For this reason, when the plunger 41 is pulled in the direction of the arrow P, the sample liquid accommodated in the heating unit 31a moves to the filter accommodating section 5a as shown by an arrow F₂ (see FIG. 2B). In addition, according to the capacity of the sample liquid accommodated in the reservoir section 21, in a process of pulling the plunger 41 and moving the sample liquid, while there is probability of introducing the air into the flow path 81 from the opening section 211, the air may be introduced into the flow path 81 after movement of the sample liquid.

A diameter of the channel 61 is set to be smaller than that of a flow-passing area (the flow paths 81 and 82) of the sample liquid between the reservoir section 21 and the channel 61. For this reason, the sample liquid arriving at the filter accommodating section 5a penetrates the holes of the filter 51 to arrive at a tip of the channel 61 connected to the filter accommodating section 5a (see an arrow F₃ of FIG. 2C). In the sample liquid, in a process of penetrating the holes of the filter 51, elements that did not penetrate the holes are removed from the sample liquid. For example, when the cells such as bacteria or the like are included in the sample liquid, since the genomes diffused in the sample liquid by the heating pass through the holes of the filter 51, and impurities, which are not necessary for the analysis such as the cell membrane or the like, do not pass through the filter 51, the impurities are removed from the sample liquid. In addition, a check valve 821 may be installed at the flow path 82 that connects the heating unit 31a and the space (the filter accommodating section 5a) (see FIG. 1A). The constitution of the valve 821 is the same as that of the above-mentioned valve 811.

When the sample liquid arrives at the tip of the channel 61, a microchip M₁ is inserted into the insertion section 71, and a portion of the microchip M₁ penetrates through the channel 61. Since a groove d into which the sample liquid is introduced is formed in the microchip M₁, the groove d of the microchip M₁ and the channel 61 are connected by the penetration of the channel 61 (see FIG. 2D). Here, when an inner space of the groove d of the microchip M₁ becomes a negative pressure with respect to the atmospheric pressure, the sample liquid in the channel 61 is injected into the microchip M₁ by a pressure difference between the groove d and the channel 61 (see an arrow F₄ of FIG. 2D).

In addition, in order to accelerate introduction of the sample liquid into the microchip M₁, when the microchip M₁ is inserted into the insertion section 71, the plunger 41 may be removed from the syringe conduit line 4. Further, as the gas liquid separation film 43a is installed between the syringe conduit line 4 and the filter accommodating section 5a, when the plunger 41 is removed from the syringe conduit line 4, the sample liquid in the filter accommodating section 5a is prevented from flowing into the syringe conduit line 4. As the plunger 41 is removed, the air flows into the filter accommodating section 5a and the channel 61 via the syringe conduit line 4, a pressure difference between the inside of the microchip M₁ and the channel 61 is held, and injection of the sample liquid into the microchip M₁ is performed for a shorter time.

In the sample liquid injection tool T₁₁ according to the first embodiment of the present disclosure, in order to prepare the sample liquid in the sample liquid injection tool T₁₁, manipulation of the heating and the filtration is performed. Accordingly, pretreatment of the sample liquid and introduction into the microchip M₁ become convenient without preparation of a separate container configured to perform pretreatment of the sample liquid or an operation of moving the pretreated sample liquid to a tool configured to inject the sample liquid. In addition, since the manipulation of the heating, filtration and injection can be performed in a state in which the sample liquid is held in one tool, contamination of the sample liquid or infection to a user when the sample liquid including an infective specimen is used can be prevented.

In addition, while a capacity of the sample liquid necessary for the analysis in the microchip M₁ is frequently about hundreds of microliters, for example, in order to suspend the specimen from the cotton swab, to which the swab is attached, in the reagent solution, about several milliliters of reagent solution is necessary. In comparison with the case in which the entire reagent solution in which the specimen is suspended is heated, in the sample liquid injection tool T₁₁, since the specimen having a capacity necessary for the analysis is moved to the heating unit 31a and heated, the heating time of the specimen can be reduced.

For example, the pretreatment of the sample by the sample liquid injection tool T₁₁ is appropriate for the case in which the analysis target is the genomes or the like of the bacteria included in the specimen. In the heating unit 31a, the cell membranes of the bacteria in the sample liquid are broken, impurities with respect to the analysis such as the cell membranes or the like are removed by the filter 51 of the filter accommodating section 5a, and the microchip M₁ can be introduced in a state in which the genomes of the bacteria are directly diffused in the sample liquid. For this reason, in the specimen introduced using the sample liquid injection tool T₁₁, reactivity with reagents necessary for a nucleic acid amplification reaction such as enzyme, primer, or the like, is increased, mixing of the impurities that disturb the reaction is reduced, and accuracy of the nucleic acid amplification reaction is improved.

In addition, as the sample liquid passes through the filter 51, the material having the size that does not pass through the holes of the filter is prevented from being introduced into the microchip M₁ and blocking the fine structure such as the flow path, the well, and so on, formed in the microchip M₁.

3. Constitution of sample liquid injection tool according to variant of first embodiment

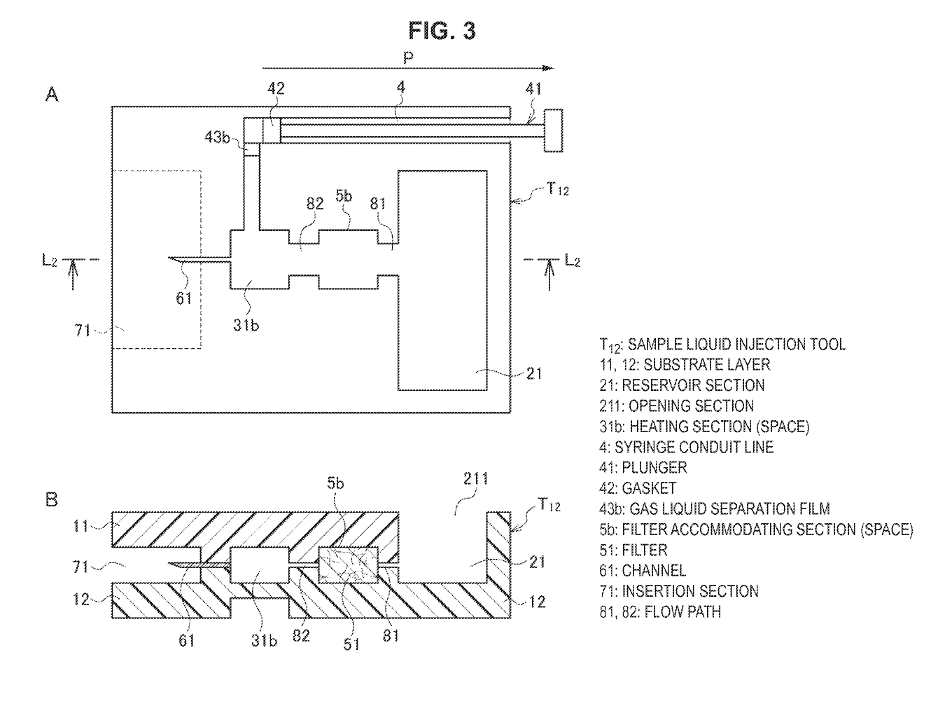

FIG. 3 is a schematic view of the sample liquid injection tool T₁₂ according to a variant of the first embodiment. FIG. 3A is a top view, and FIG. 3B is a cross-sectional view taken along line L₂-L₂ of FIG. 3A. In the sample liquid injection tool T₁₂, a constitution other than that of a heating unit 31b and a filter accommodating section 5b is the same as in the first embodiment. The same elements as the first embodiment are designated by the same reference numerals, and overlapping description will not be repeated.

(1) Filter Accommodating Section

In the sample liquid injection tool T₁₂, the filter accommodating section 5b is disposed between the reservoir section 21 and the heating unit 31b. In addition, like the sample liquid injection tool T₁₁, the filter 51 is installed in the filter accommodating section 5b.

(2) Heating Unit

In the sample liquid injection tool T₁₂, the heating unit 31b comes in communication with the channel 61 and the cylinder conduit line 4. In addition, unlike the sample liquid injection tool T₁₁, the thermal conductive member 311 is not installed at the heating unit 31b. In the sample liquid injection tool according to the present disclosure, the thermal conductive member 311 is not a necessary constitution. Heating of the sample liquid in the sample liquid injection tool T₁₂ will be described below.

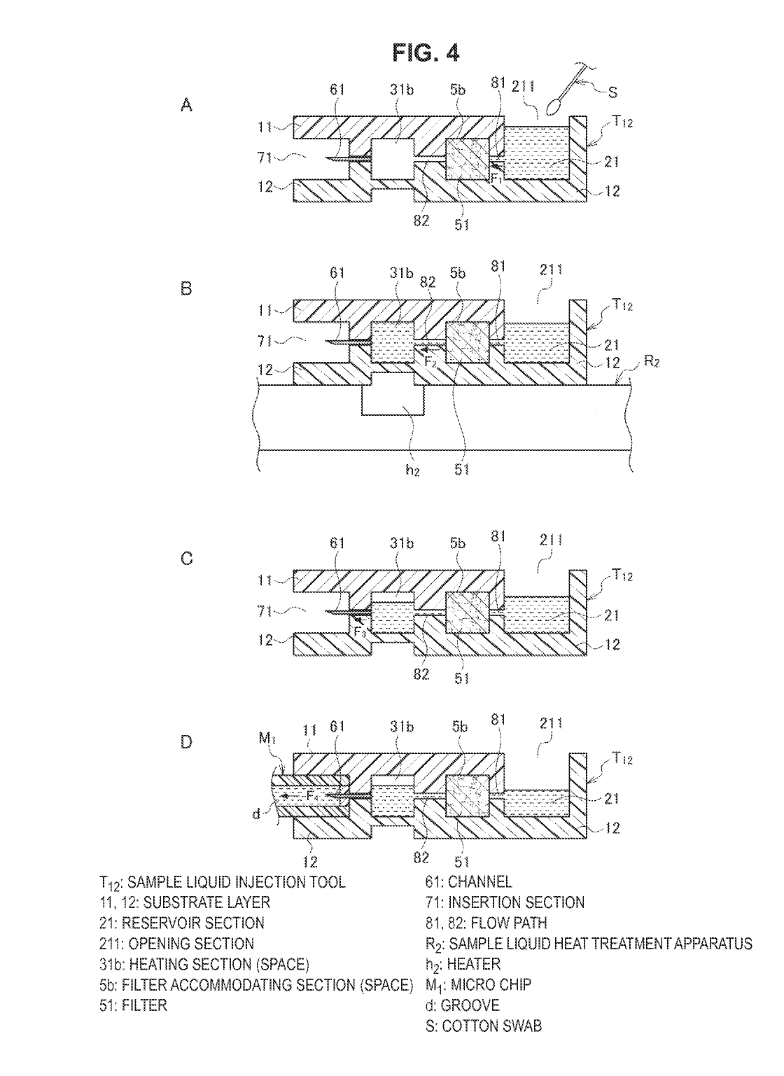

The pretreatment method and the injection method of the sample liquid by the sample liquid injection tool T₁₂ will be described with reference to FIGS. 4A to 4D. In addition, the same parts as the pretreatment method and the injection method of the sample liquid by the sample liquid injection tool T₁₁ will not be described.

Like the sample liquid injection tool T₁₁, the sample liquid accommodated in the reservoir section 21 is to be flowed into the filter accommodating section 5b (see the arrow F₁ of FIG. 4A) by pulling the plunger 41 inserted into the syringe conduit line 4 in the direction shown by the arrow P. In the sample liquid injection tool T₁₂, since the filtration by the filter 51 is performed before the heating of the sample liquid, an element having a larger size than the analysis target included in the sample liquid at this time is excluded.

The sample liquid in the filter accommodating section 5b flows into the heating unit 31b by pulling the plunger 41 in the syringe conduit line 4 from the syringe conduit line 4 (see the arrow F₂ of FIG. 4B). Here, the heater h₂ of the sample liquid heat treatment apparatus R₂ comes in contact with the sample liquid injection tool T₁₂ to heat the sample liquid. In addition, since the flowing of the sample liquid from the reservoir section 21 to the filter accommodating section 5b (see the arrow F₁ of FIG. 4A) and the flowing from the filter accommodating section 5b to the heating unit 31b (see the arrow F₂ of FIG. 4B) are performed as continuous manipulation, there is no need to keep the sample liquid in the filter accommodating section 5b all at once. For this reason, in the flow paths 81 and 82 of the sample liquid injection tool T₁₂, the valves 811 and 821 may not be provided.

In the sample liquid injection tool T₁₂, in order to accelerate the heating of the sample liquid, a contact portion of the heating unit 31b with the sample liquid heat treatment apparatus R₂ is formed to have the substrate layer 12 thinner than other portions. As the contact portion of the substrate layer 12 with the heater h₂ is thinned, transfer of heat of the heater h₂ to the sample liquid is more efficiently performed.

In the sample liquid in which the heating is terminated, the plunger 41 inserted into the syringe conduit line 4 is further extracted, and the sample liquid arrives at the tip of the channel 61 connected to the heating unit 31b (see the arrow F₃ of FIG. 4C).

After the sample liquid arrives at the tip of the channel 61, as shown in FIG. 4D, the microchip M₁ is inserted from the insertion section 71, a portion of the microchip M₁ penetrates the channel 61, and the sample liquid in the channel 61 is injected into the groove d in the microchip M₁ (see the arrow F₄ of FIG. 4D).

In the above-mentioned the sample liquid injection tool T₁₂, the preparation of the sample liquid is constituted by the filtration by the filter 51 and then the heating. For this reason, for example, the preparation is appropriate for the case in which the virus genome, the nucleic acid, and so on, which are directly diffused in the specimen, are used as the analysis target. When the analysis target is the virus genome, the virus particle and the impurities included in the sample liquid are separated through the filtration by the filter 51, an envelope included in the virus particle is degenerated by the heating in the heating unit 31b, and the virus genomes are diffused in the sample liquid. Other effects of the sample liquid injection tool T₁₂ are the same as the sample liquid injection tool T₁₁.

4. Constitution of sample liquid injection tool according to second embodiment of present disclosure

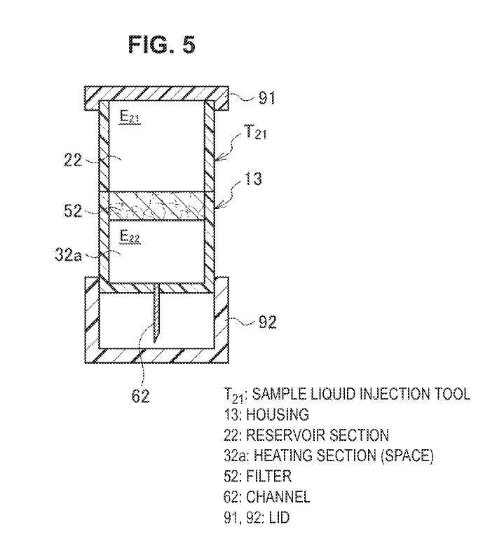

FIG. 5 is a cross-sectional schematic view of the sample liquid injection tool of the second embodiment designated by reference character T₂₁. In the sample liquid injection tool T₂₁, a channel 62 is connected to a housing 13 having a substantially cylindrical shape. A reservoir section 22 configured to accommodate the sample liquid and a heating unit 32a are installed in the housing 13, and the reservoir section 22 and the heating unit 32a are partitioned by a filter 52. In addition, the housing 13 may have a substantially prismatic shape or a substantially polygonal pillar shape, in addition to the substantially cylindrical shape, but the shape is not limited to the shape shown in FIG. 5. Further, plastics may be used as a material constituting the housing 13.

In addition, in the sample liquid injection tool T₂₁, in order to prevent an accident in which a user's hand or the like is carelessly stabbed by the channel 62 and enable self-support of the sample liquid injection tool T₂₁, a lid 92 may be provided on the channel 62. Further, a lid 91 may be provided to prevent contamination to the sample liquid in the reservoir section 22. The respective elements of the sample liquid injection tool T₂₁ will be sequentially described.

(1) Reservoir Section

The reservoir section 22 is a space E₂₁ configured to accommodate a reagent solution, and like the case of the sample liquid injection tool ₁₁ according to the first embodiment, may also be used as a space for mixing the reagent solution and the specimen. A surface of the housing 13 constituting the reservoir section 22 may be configured to be deformable in the filtration of the sample liquid. Various kinds of elastomers, natural rubber, or the like, may be used as a deformable material.

(2) Filter

The filter 52 installed at the sample liquid injection tool T₂₁ is the same as the filter described in the first embodiment. A material or a hole diameter of the filter may be appropriately selected to match characteristics of the specimen or the analysis target.

(3) Heating Unit

The heating unit 32a is a space E₂₂ configured to heat the sample liquid in the sample liquid injection tool T₂₁. In the sample liquid injection tool T₂₁, unlike the first embodiment, the thermal conductive member 311 is not provided in the heating unit 32a. For this reason, the surface constituting the heating unit 32a may be formed of a thermoplastic material to sufficiently transfer the heat to the mixed liquid. The heating of the sample liquid in the heating unit 32a will be described below.

(4) Channel

The channel 62 installed at the sample liquid injection tool T₂₁ is the same as the channel described in the first embodiment. The channel 62 has one end connected to the heating unit 32a and the other end protruding from the sample liquid injection tool T₂₁.

5. Pretreatment and injection of sample liquid by sample liquid injection tool according to second embodiment

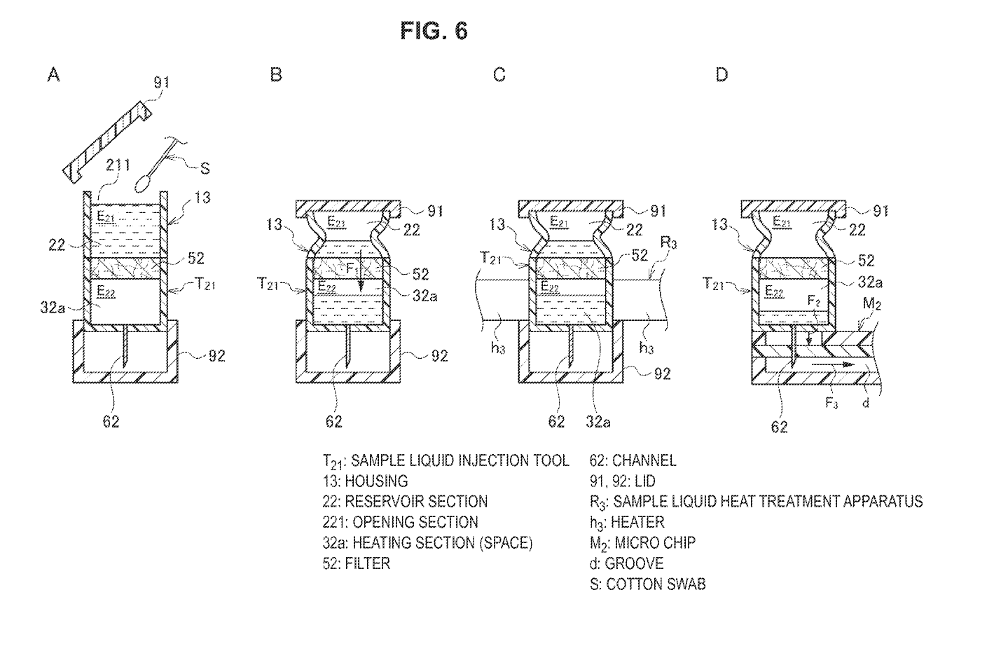

A pretreatment method and an injection method of the sample liquid by the sample liquid injection tool T₂₁ will be described with reference to FIGS. 6A to 6D.

As shown in FIG. 6A, a reagent solution is accommodated in the reservoir section 22. The cotton swab S to which the specimen such as a swab or the like is attached is inserted into the reagent solution and the specimen is suspended in the reagent solution.

After the suspension of the specimen into the reagent solution is terminated, the lid 91 may be provided on the reservoir section 22. After that, an external force is applied to the sample liquid as a user pushes the reservoir section 22 from the outside of the sample liquid injection tool T₂₁ with his/her finger or the like, and the sample liquid passes through the filter 52 as shown by the arrow F₁ and flows into the heating unit 32a (see FIG. 6B).

The sample liquid in the heating unit 32a is heated using the sample liquid heat treatment apparatus R₃ (see FIG. 6C). In the heater h₃ of the sample liquid heat treatment apparatus R₃, when the heater h₁ is in contact with the heating unit 32a efficiently transmits heat of the heater h₃ to the sample liquid in comparison with a case in which the heater h₃ is not in contact with the heating unit 32a. Here, when a portion of the housing 13 in contact with the heater h₃ is formed of a thermoplastic material, adhesion between the housing 13 and the heater h₃ is increased, and transfer of heat generated by the heater h₃ to the sample liquid is more efficiently performed.

In the sample liquid in which the heating in the heating unit 32a is terminated, the channel 62 penetrates a portion of the microchip M₂ to connect the heating unit 32a and the groove d formed in the microchip M₂, and the sample liquid is injected into the microchip M₂ (see an arrow F₂ of FIG. 6D). Here, when the inner space of the groove d of the microchip M₂ is a negative pressure with respect to the atmospheric pressure, the sample liquid in the channel 62 is injected into the microchip M₂ by a pressure difference between the groove d and the channel 62 (see an arrow F₃ of FIG. 6D).

Since the sample liquid injection tool T₂₁ according to the second embodiment of the present disclosure does not require the constitution such as the syringe conduit line 4, the plunger 41, or the like, unlike the first embodiment, the constitution of the sample liquid injection tool T₂₁ can be simplified. For this reason, the size of the sample liquid injection tool T₂₁ can be reduced. Other effects of the sample liquid injection tool T₂₁ are the same as those of the first embodiment.

6. Constitution of sample liquid injection tool according to variant of second embodiment

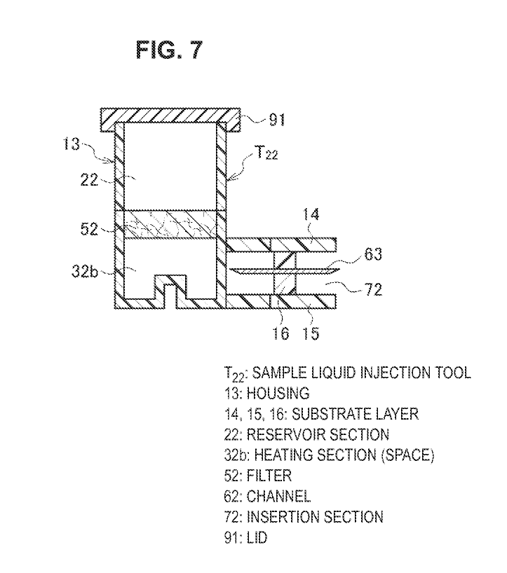

FIG. 7 shows a cross-sectional schematic view of a sample liquid injection tool T₂₂ according to a variant of the second embodiment. In the sample liquid injection tool T₂₂, other components than a heating unit 32b, a channel 63 and an insertion section 72 are the same as the second embodiment. The same components as the second embodiment are designated by the same reference numerals, and overlapping description will not be repeated.

(1) Heating Unit

In the sample liquid injection tool T₂₂, a portion of a bottom surface of the heating unit 32b is concaved toward the inside of the heating unit 32b. The heating of the sample liquid in the heating unit 32b will be described below.

(2) Channel

As shown in FIG. 7, the channel 63 of the sample liquid injection tool T₂₂ is not connected to the heating unit 32b. The channel 63 has a portion fixed to a substrate layer 16, which will be described below, and both ends protruding inward the insertion section 72.

(3) Insertion Section

In the sample liquid injection tool T₂₂, substrate layers 14 and 15 forming the insertion section 72 are connected to the housing 13. The insertion section 72 is a space into which the microchip is inserted, like the insertion section 71 of the first embodiment. The insertion section 72 in FIG. 7 is constituted by the plurality of substrate layers 14, 15 and 16. The substrate layers 14 and 15 connected to the housing 13 at one ends thereof may have a connecting portion to the housing 13 formed of a material having flexibility for reasons to be described below. In addition, the insertion section 72 may be configured such that the channel 63 installed therein can be connected to the housing 13 and penetration of the channel 63 to the microchip is not disturbed, and is not limited to a shape shown in FIG. 7. In addition, like the insertion section 71 of the first embodiment, as the insertion section 72 is provided in the sample liquid injection tool T₂₂, the penetration of the microchip by the channel 63 can be easily positioned.

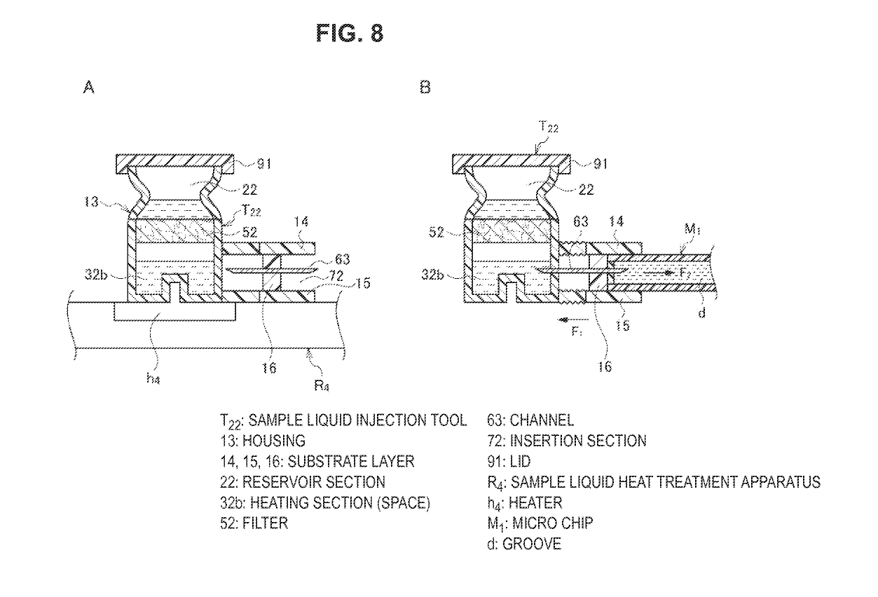

A pretreatment method and an injection method of the sample liquid by the sample liquid injection tool T₂₂ will be described with reference to FIGS. 8A and 8B. In addition, the same parts as the pretreatment method and the injection method of the sample liquid by the sample liquid injection tool according to the second embodiment will not be described.

FIG. 8A shows a state in which a portion of the housing 13 in which the sample liquid is accommodated, corresponding to the reservoir section 22, is pressed from the outside, and the sample liquid passes through the filter 52 to be introduced into the heating unit 32b. The heating of the sample liquid accommodated in the heating unit 32b can be performed using a sample liquid heat treatment apparatus R₄.

A portion of a heater h₄ installed at the sample liquid heat treatment apparatus R₄ is formed in a convex shape. Meanwhile, a portion of a surface of the housing 13 of the sample liquid injection tool T₂₂ constituting the heating unit 32b is recessed in a concave shape. For this reason, the heater h₄ is fitted into a recess of the heating unit 32b, the heating unit 32b and the heater h₄ are adhered, and the sample liquid in the heating unit 32b is heated.

In injection of the sample liquid, in which the heating in the heating unit 32b is terminated, into the microchip M₁, the microchip M₁ is inserted into the insertion section 72, the channel 63 installed in the insertion section 72 is pressed to the heating unit 32b, and the housing 13 is penetrated.

As shown in FIG. 8B, when the microchip M₁ is inserted into the insertion section 72, one end of the channel 63 penetrates through a portion of the microchip M₁, and the channel 63 is connected to the groove d in the microchip M₁. Here, since a portion of the insertion section 72 connected to the housing 13 has flexibility, the portion is bent by an external force that inserts the microchip M₁ into the insertion section 72 (see the arrow F₁ of FIG. 8B). As a result, the other end of the channel 63 penetrates the housing 13, and the heating unit 32b is connected to the channel 63. As the heating unit 32b and the groove d are connected via the channel 63, the sample liquid is injected into the microchip M₁ (see the arrow F₂ of FIG. 8B).

In the sample liquid injection tool T₂₂, as a portion of the housing 13 constituting the heating unit 32b is formed in a concave shape, a contact area with the heater h₄ is increased, and the heating of the sample liquid by the sample liquid heat treatment apparatus R₄ can be efficiently performed. For this reason, a time to inject the sample liquid into the microchip M₁ can be reduced. Other effects of the sample liquid injection tool T₂₂ are the same as those of the sample liquid injection tool T₂₁ according to the second embodiment of the present disclosure.

It should be understood by those skilled in the art that various modifications, combinations, sub-combinations and alterations may occur depending on design requirements and other factors insofar as they are within the scope of the appended claims or the equivalents thereof.

Additionally, the present application may also be configured as below.
(1) A sample liquid injection tool including:
   a reservoir section configured to store a sample liquid;
   a channel having one end protruding from an outer surface and configured to discharge the sample liquid therein from a protrusion end to an outside; and
   a heating unit and a filter installed between the reservoir section and the channel to enable passage of the liquid.
(2) The sample liquid injection tool according to (1), further including:
   a cylinder conduit line having one end opened at the outside and the other end in communication with a space to which the channel is directly connected;
   a plunger inserted into the cylinder conduit line; and
   a gas liquid separation film disposed inside the cylinder conduit line or at a communication hole to the space.
(3) The sample liquid injection tool according to (2), further including:
   a thermal conductive member installed at the heating unit,
   wherein the thermal conductive member is able to come in contact with the sample liquid accommodated in the heating unit, and a portion of the thermal conductive member is disposed to be exposed to the outside.
(4) The sample liquid injection tool according to any one of (1) to (3),
   wherein a diameter of the channel is smaller than a diameter of a passing area of the sample liquid between the reservoir section and the channel.
(5) The sample liquid injection tool according to any one of (1) to (4),
   wherein a volume of the heating unit is smaller than a volume of the reservoir section.
(6) The sample liquid injection tool according to any one of (1) to (5),
   wherein the heating unit is connected to the reservoir section and a space in which the filter is disposed is connected to the heating unit, and
   wherein the channel and the cylinder conduit line are in communication with the space at a downstream side in a liquid-passing direction of the filter.
(7) The sample liquid injection tool according to (6),
   wherein valves are disposed at the passing area of the sample liquid between the reservoir section and the heating unit, and between the heating unit and the space.
(8) The sample liquid injection tool according to (7),
   wherein a communication hole of the cylinder conduit line to the space is disposed closer to a communication hole of the channel to the space than a connecting hole of the heating unit to the space.
(9) The sample liquid injection tool according to any one of (3) to (8),
   wherein the thermal conductive member is formed of copper or aluminum.
(10) The sample liquid injection tool according to any one of (1) to (9),
   wherein an average hole diameter of the filter is 0.1 to 10 μm.
(11) The sample liquid injection tool according to any one of (1) to (10),
   wherein the channel penetrates a microchip in which a groove into which the sample liquid is introduced is formed.
(12) The sample liquid injection tool according to (11),
   wherein an inner space of the groove becomes a negative pressure with respect to an atmospheric pressure.
(13) The sample liquid injection tool according to (1) to (12),
   wherein the tool is formed by stacking substrate layers formed of plastic.
(14) The sample liquid injection tool according to (13),
   wherein an insertion section into which the microchip is inserted is configured between the substrate layers, and
   wherein the channel has one end protruding to the insertion section in a layer direction of the substrate layers.
(15) The sample liquid injection tool according to any one of (1) to (5),
   wherein the filter is disposed between the reservoir section and the heating unit, and
   wherein the channel and the cylinder conduit line come in communication with the heating unit.

According to the sample liquid injection tool of an embodiment of the present disclosure, the sample liquid can be conveniently heated and filtered. Accordingly, the specimen analyzed by the microchip can be conveniently prepared. In addition, in analysis of the specimen performed using the microchip or the like by the pretreatment of the specimen, accuracy of the analysis is improved. For this reason, the sample liquid injection tool according to the present disclosure can be appropriately applied to the pretreatment or the like for analysis using a small amount of specimen of the nucleic acid amplification reaction or the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A sample liquid injection tool comprising:
a reservoir section configured to store a sample liquid;
a channel having one end protruding from an outer surface and configured to discharge the sample liquid therein from a protrusion end to an outside; and
a heating unit and a filter installed between the reservoir section and the channel to enable passage of the liquid.

2. The sample liquid injection tool according to claim 1, further comprising:
a cylinder conduit line having one end opened at the outside and the other end in communication with a space to which the channel is directly connected;
a plunger inserted into the cylinder conduit line; and
a gas liquid separation film disposed inside the cylinder conduit line or at a communication hole to the space.

3. The sample liquid injection tool according to claim 2, further comprising:
a thermal conductive member installed at the heating unit,
wherein the thermal conductive member is able to come in contact with the sample liquid accommodated in the heating unit, and a portion of the thermal conductive member is disposed to be exposed to the outside.

4. The sample liquid injection tool according to claim 3,
wherein a diameter of the channel is smaller than a diameter of a passing area of the sample liquid between the reservoir section and the channel.

5. The sample liquid injection tool according to claim 4,
wherein a volume of the heating unit is smaller than a volume of the reservoir section.

6. The sample liquid injection tool according to claim 5,
wherein the heating unit is connected to the reservoir section and a space in which the filter is disposed is connected to the heating unit, and
wherein the channel and the cylinder conduit line are in communication with the space at a downstream side in a liquid-passing direction of the filter.

7. The sample liquid injection tool according to claim 6,
wherein valves are disposed at the passing area of the sample liquid between the reservoir section and the heating unit, and between the heating unit and the space.

8. The sample liquid injection tool according to claim 7,
wherein a communication hole of the cylinder conduit line to the space is disposed closer to a communication hole of the channel to the space than a connecting hole of the heating unit to the space.

9. The sample liquid injection tool according to claim 8,
wherein the thermal conductive member is formed of copper or aluminum.

10. The sample liquid injection tool according to claim 9,
wherein an average hole diameter of the filter is 0.1 to 10 μm.

11. The sample liquid injection tool according to claim 10,
wherein the channel penetrates a microchip in which a groove into which the sample liquid is introduced is formed.

12. The sample liquid injection tool according to claim 11,
wherein an inner space of the groove becomes a negative pressure with respect to an atmospheric pressure.

13. The sample liquid injection tool according to claim 12,
wherein the tool is formed by stacking substrate layers formed of plastic.

14. The sample liquid injection tool according to claim 13,
wherein an insertion section into which the microchip is inserted is configured between the substrate layers, and
wherein the channel has one end protruding to the insertion section in a layer direction of the substrate layers.

15. The sample liquid injection tool according to claim 5,
wherein the filter is disposed between the reservoir section and the heating unit, and
wherein the channel and the cylinder conduit line come in communication with the heating unit.

16. A sample liquid heat treatment apparatus, comprising a heater in contact with the thermal conductive member of the sample liquid injection tool according to claim 3.

17. The sample liquid heat treatment apparatus according to claim 16,
wherein the heater is a Peltier element.
